(19) United States
(12) Patent Application Publication
(10) Pub. No.: US 2015/0317005 A1
(43) Pub. Date: Nov. 5, 2015

(54) DISPLAY DEVICE AND CONTROL METHOD THEREOF

(71) Applicant: LG ELECTRONICS INC., Seoul (KR)

(72) Inventors: Jihwan KIM, Seoul (KR); Sihwa PARK, Seoul (KR); Yongsin KIM, Seoul (KR)

(21) Appl. No.: 14/322,588

(22) Filed: Jul. 2, 2014

(30) Foreign Application Priority Data
Apr. 30, 2014 (KR) 10-2014-0052082

(51) Int. Cl. G06F 3/041; G06F 3/0488; G05B 19/18; G06F 3/0484

(52) U.S. Cl. CPC G06F 3/041; G06F 3/04847; G06F 3/04883; G05B 19/188; G05B 2219/45013

(57) ABSTRACT

Disclosed is a display device including a scent emission unit to emit scents, a sensor unit to sense input to the display device, a display unit to display content, and a processor to control the scent emission unit, the sensor unit and the display unit. The processor detects page transition input while a first page included in the content is being displayed on the display unit, implements transition from the first page to a second page in response to the page transition input, and detects a page transition speed. Then, the processor emits a scent corresponding to the second page based on the page transition speed. The processor emits the scent at a first emission speed when the page transition speed exceeds a threshold speed, and emits the scent at a second emission speed faster than the second emission speed when the page transition speed is the threshold speed or less.

This application claims the benefit of Korean Patent Application No. 10-2014-0052082, filed on, Apr. 30, 2014, which is hereby incorporated by reference as if fully set forth herein.

### BACKGROUND OF THE INVENTION

1. Field of the Invention

The present specification relates to a display device and a control method thereof.

2. Discussion of the Related Art

With development of various contents, display devices to provide a user with content in a more realistic and effective manner have actively been developed. In particular, a variety of technologies for stimulating the five senses of a user including senses of sight, smell, touch, taste and hearing and providing content in a more realistic manner are under development. In particular, a scent emission unit to stimulate the sense of smell of a user has actively been developed. A display device may include a scent emission unit to emit various kinds of scent according to displayed content, thereby providing a user with content in a more vivid and realistic manner.

However, in the case of contents including plural pages, such as an e-book, there is a problem in that scent corresponding to each page may not be emitted at an appropriate point in time and in an appropriate amount upon page transition. Accordingly, there occurs malfunction in which scent corresponding to each page may be emitted in a manner contrary to user selection or may not be emitted.

### SUMMARY OF THE INVENTION

Accordingly, the present specification is directed to a display device and a control method thereof that substantially obviate one or more problems due to limitations and disadvantages of the related art.

According to one embodiment, a display device may control a scent emission speed by detecting a page transition speed.

In addition, according to another embodiment, a display device may control a scent emission speed by adjusting a scent emission point in time, a scent emission intensity, a diffusion facilitating unit and a scent emission amount.

In addition, according to still another embodiment, a display device may emit plural scents in a predetermined sequence.

In addition, according to a further embodiment, a display device may determine a representative scent among plural scents corresponding to plural pages and emit the determined representative scent.

To achieve these objects and other advantages and in accordance with one embodiment of the specification, as embodied and broadly described herein, a display device includes a scent emission unit configured to emit scents, a sensor unit configured to sense input to the display device, a display unit configured to display content including plural pages, and a processor configured to control the scent emission unit, the sensor unit and the display unit, wherein the processor is further configured to detect page transition input from a first page to a second page while the first page included in the content is being displayed on the display unit, switch the first page to the second page in response to the detected page transition input and detect a page transition speed from the first page to the second page, and emit a scent corresponding to the switched second page based on the detected page transition speed, wherein the processor emits the scent at a first emission speed when the detected page transition speed exceeds a threshold speed, wherein the processor emits the scent at a second emission speed when the detected page transition speed is equal to or less than the threshold speed, and wherein the first emission speed is faster than the second emission speed.

It is to be understood that both the foregoing general description and the following detailed description of the present specification are exemplary and explanatory and are intended to provide further explanation of the specification as claimed.

### BRIEF DESCRIPTION OF THE DRAWINGS

The accompanying drawings, which are included to provide a further understanding of the specification and are incorporated in and constitute a part of this application, illustrate embodiment(s) of the specification and together with the description serve to explain the principle of the specification. In the drawings:

FIG. 1 is a functional block diagram of a display device according to one embodiment;

FIG. 2 is a view showing one embodiment of a display device equipped with a scent emission unit;

FIG. 3 is a view showing one embodiment of content including plural pages;

FIG. 4 is a view showing one embodiment of a display device displaying a first page;

FIG. 5 is a view showing one embodiment of a display device detecting a page transition speed from a first page to a second page;

FIG. 6 is a view showing one embodiment of a display device detecting a page transition speed from a first page to a second page;

FIG. 7 is a view showing one embodiment of a display device controlling a scent emission speed based on a page transition speed;

FIG. 8 is a view showing one embodiment of a display device emitting plural scents in a predetermined sequence;

FIG. 9 is a view showing one embodiment of a display device emitting a representative scent among plural scents corresponding to plural pages;

FIG. 10 is a view showing one embodiment of a display device including a plurality of scent emitters;

FIG. 11 is a view showing one embodiment of a display device including a flexible display panel; and

FIG. 12 is a flowchart showing a control method of a display device.

### DETAILED DESCRIPTION OF THE INVENTION

Although the terms used in the following description are selected, as much as possible, from general terms that are widely used at present while taking into consideration the functions obtained in accordance with the present specification, these terms may be replaced by other terms based on intensions of those skilled in the art, customs, emergence of new technologies, or the like. Also, in a particular case, terms that are arbitrarily selected by the applicant of the present specification may be used. In this case, the meanings of these terms may be described in corresponding description parts of the specification. Accordingly, it should be noted that the terms used herein should be construed based on practical meanings thereof and the whole content of this specification, rather than being simply construed based on names of the terms.

In addition, although embodiments will be described in detail with reference to the accompanying drawings and content illustrated in the accompanying drawings, the disclosure is not limited or restricted by the embodiments.

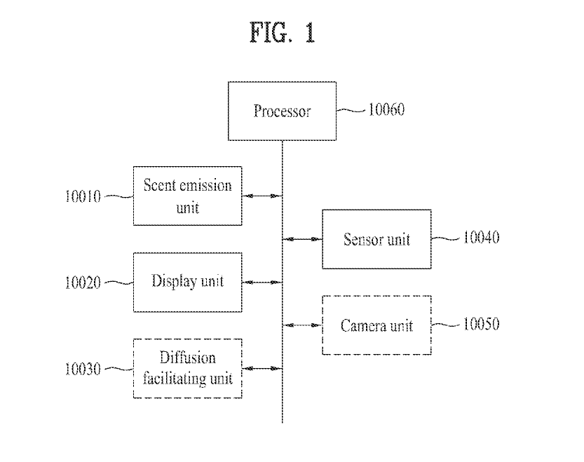

FIG. 1 is a functional block diagram of a display device according to one embodiment. Referring to FIG. 1, the display device may include a scent emission unit 10010, a display unit 10020, a diffusion facilitating unit 10030, a sensor unit 10040, a camera unit 10050 and a processor 10060. Note that FIG. 1 shows one embodiment and some constituent units may be omitted or new constituent units may be added according to requirements of those skilled in the art.

The scent emission unit 10010 may emit scents. Here, “scent” may refer to an olfactory stimulation material that may be perceived via the sense of smell of a user. Thus, “scent” may refer to not only fragrant odors, but also various olfactory information that may be perceived via the sense of smell. The scent emission unit 10010 may directly generate scent by mixing or blending various olfactory stimulation materials and may emit the generated scent. In this case, the scent emission unit 10010 may include a reservoir in which olfactory stimulation materials, raw materials, neutralizing materials for neutralization of a specific scent and the like, required to compose scent, are stored.

The sensor unit 10040 may sense input to the display device. More specifically, the sensor unit 10040 may sense input to the display device using at least one sensor mounted to the display device and transmit the sensed result to the processor 10060. Here, the at least one sensor may be a gravity sensor, a geomagnetic sensor, a motion sensor, a gyro sensor, an accelerometer, an infrared sensor, an inclination sensor, a brightness sensor, a height sensor, an olfactory sensor, a temperature sensor, a depth sensor, a pressure sensor, a bending sensor, an audio sensor, a video sensor, a Global Positioning System (GPS) sensor, a grip sensor or a touch sensor. The sensor unit 10040 is a generic term for the above described various sensing means. In addition, the sensor unit 10040 may sense a variety of user inputs and user environments and transmit the sensed result to the processor 10060 so as to allow the processor 10060 to implement an operation based on the sensed result. The aforementioned sensors may be provided as individual elements included in the display device, or may be combined to constitute at least one element.

In particular, in the present specification, the sensor unit 10040 may detect a touch input to the display device. More specifically, in the present specification, the sensor unit 10040 may detect a touch input to the display unit 10020 equipped in the display device. Thus, the sensor unit 10040 may be integrated with the display unit 10020, or may take the form of a plurality of layers equipped in the display device. The sensor unit 10040 may sense various contact type or non-contact type touch inputs, such as a slide touch input, multi-touch input, long-press touch input, short-press touch input, drag touch input, hovering input, flicking touch input and the like. In addition, the sensor unit 10040 may sense touch input implemented by various touch input tools, such as a touch pen, a stylus pen and the like. The sensor unit 10040 may transmit the sensed result of various touch inputs to the processor 10060.

The display unit 10020 may display an image. In other words, the display unit 10020 may display an image on a display screen. The display unit 10020 may display an image based on a control instruction of the processor 10060. Here, “image” may refer to a picture, photograph, text, moving image, content and the like that may be perceived via the sense of sight of a user. In particular, in the present specification, “image” may refer to content including plural pages. Accordingly, the display unit 10020 may display content including plural pages based on a control instruction of the processor 10060.

The camera unit 10050 may capture an image. More specifically, the camera unit 10050 may capture an image using at least one camera sensor mounted to the display device. In particular, in the present specification, the camera unit 10050 may capture a user image. Here, “user image” may refer to a captured image of a specific body region of a user, such as the user's face, the user's eyes, etc. The camera unit 10050 may transmit the captured result to the processor 10060.

The diffusion facilitating unit 10030 may facilitate diffusion of scent emitted from the scent emission unit 10010. For example, the diffusion facilitating unit 10030 may blow air or generate an atmospheric pressure difference so as to facilitate diffusion of scent molecules emitted from the scent emission unit 10010. In this case, the diffusion facilitating unit 10030 may be a fan that is capable of blowing air. The diffusion facilitating unit 10030 may be used to control a diffusion speed of scent emitted from the scent emission unit 10010. Accordingly, the diffusion facilitating unit 10030 may be incorporated in the scent emission unit 10010, or may be located near the scent emission unit 10010.

Meanwhile, the camera unit 10050 and the diffusion facilitating unit 10030 as described above may be selectively included in the display device according to embodiments.

The processor 10060 may process internal data of the display device to implement various control operations. In addition, the processor 10060 may control the aforementioned respective units and control transmission and/or reception of data between the units.

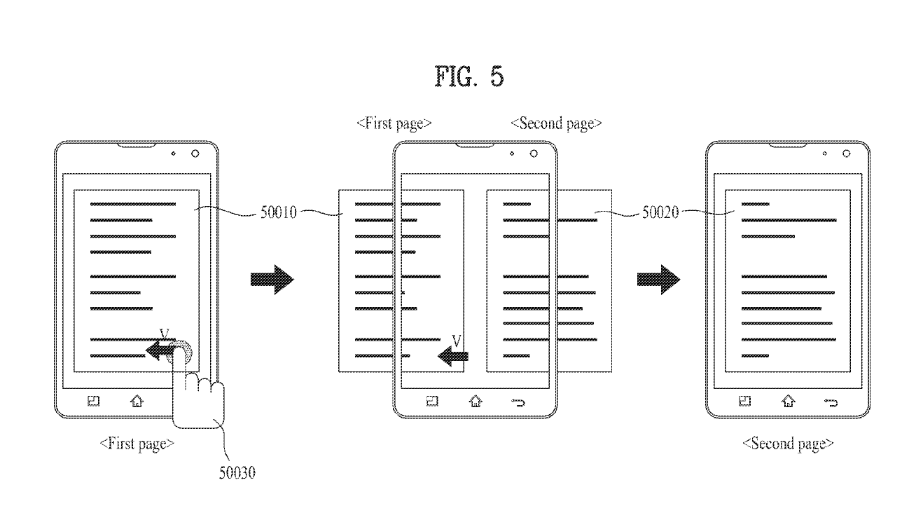

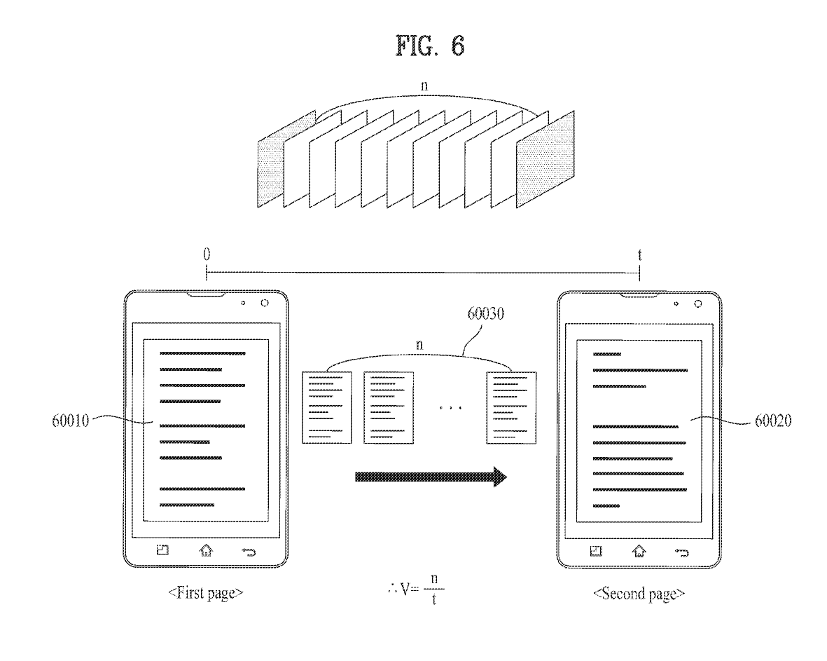

In the present specification, the processor 10060 may emit scents corresponding to displayed content. More specifically, when content including plural pages is displayed, the processor 10060 may emit scents corresponding to each page using the scent emission unit 10010. In this case, the processor 10060 may detect a page transition speed of the pages included in the content. For example, the processor 10060 may detect a page transition speed from a first page to a second page. The page transition speed is detectable according to various embodiments and a detailed description thereof will follow with regard to FIGS. 5 and 6.

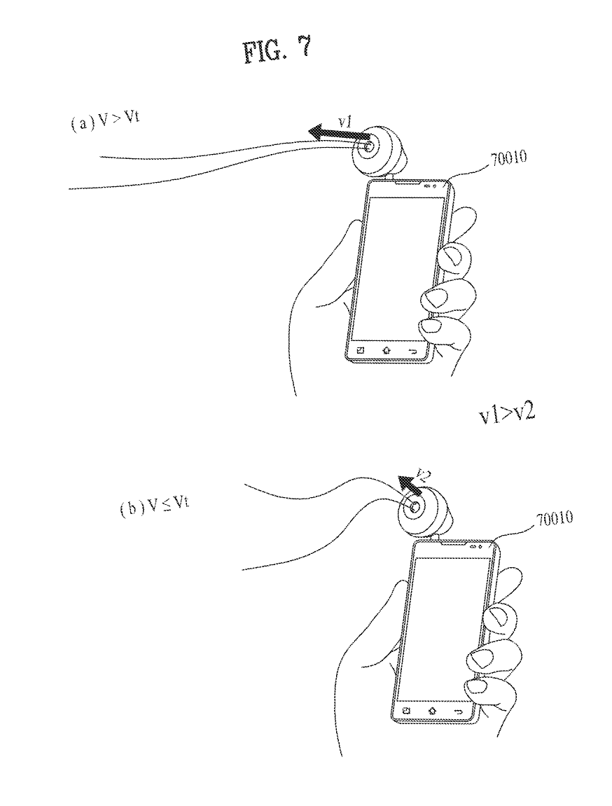

Once the page transition speed has been detected, the processor 10060 may control an emission speed of scent from the scent emission unit 10010 based on the detected page transition speed. Here, the emission speed of scent may refer to an emission distance of scent molecules for a predetermined time. More specifically, the processor 10060 may control the scent emission speed by comparing the page transition speed with a threshold speed. A detailed description related to the present embodiment will follow with regard to FIG. 7.

Hereinafter, in a case in which each step or operation implemented by the display device is initiated or implemented upon sensing of user input, generation and reception of a signal in response to the sensed user input should be construed as including a description related to the above process even without a repeated description thereof. In addition, the processor 1060 may be described as controlling the display device or at least one unit included in the display device in response to user input and the processor 10060 and the display device may be identified with each other.

Meanwhile, FIG. 1 shows the display device according to one embodiment in block diagram, and separately shown blocks represent logically separated hardware elements of the device. Thus, the elements of the device as described above may be mounted as one chip or a plurality of chips according to design of the device.

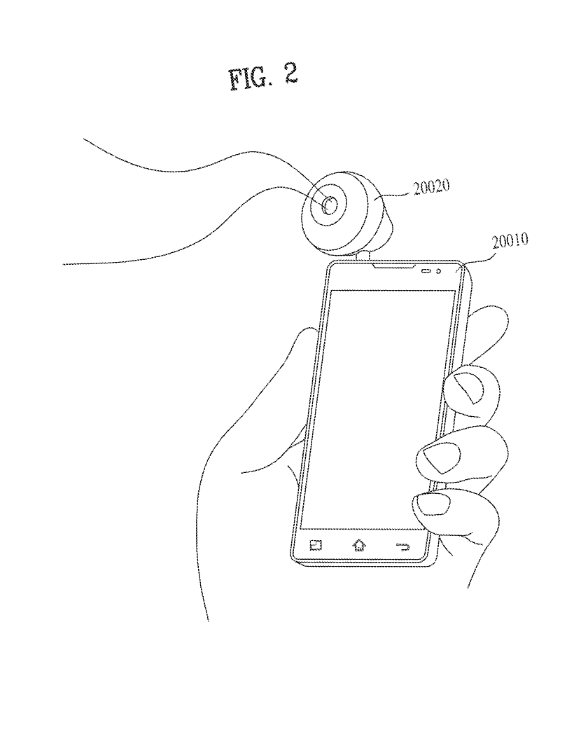

FIG. 2 is a view showing one embodiment of a display device equipped with a scent emission unit.

A scent emission unit 20020 may be incorporated in a display device 20010 in various ways. In one embodiment, the scent emission unit 20020 may be integrally mounted to the display device 20010. In this case, separation of the scent emission unit 20020 from the display device 20010 may be impossible. In another embodiment, the scent emission unit 20020, as exemplarily shown in the drawing, may be detachably attached to the display device 20010. In this case, the scent emission unit 20020 may be selectively attached to or detached from the display device 20010. Thus, a user may use the scent emission unit 20020 as needed by detaching the scent emission unit 20020 from the display device 20010 or attaching the scent emission unit 20020 to the display device 20010.

The display device 20010 may control the scent emission unit 20020 so as to emit various kinds of scents corresponding to an image displayed on a display unit. For example, when a flower image is displayed on the display unit, the display device 20010 may emit a scent of a flower using the scent emission unit 20020.

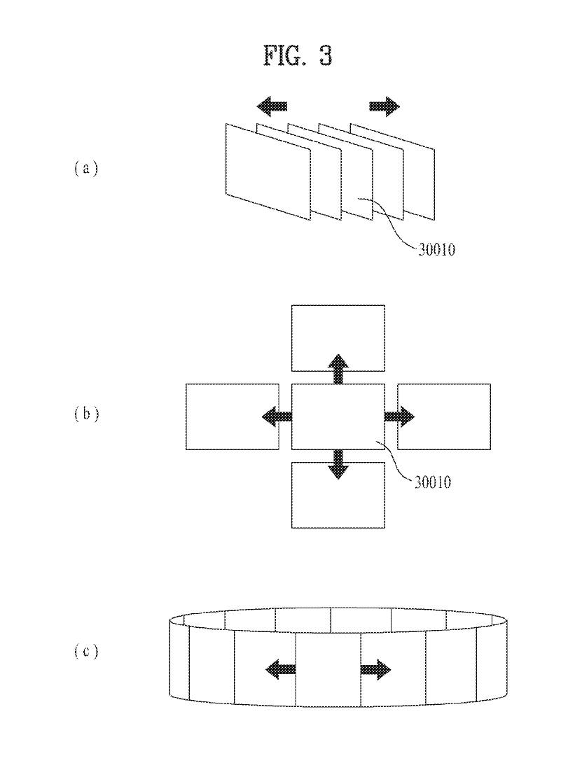

In particular, in the present specification, the display device 20010 may emit various kinds of scents corresponding to displayed content. Here, content may refer to visual information including plural pages having a given sequence. For example, content may refer to various digital content including plural pages, such as books, newspapers, magazines, etc. The plural pages included in the content may be arranged in a given sequence and page transition from one page to another page may be implemented based on a page transition direction. A detailed description related to this will follow with regard to FIG. 3.

FIG. 3 is a view showing one embodiment of content including plural pages.

As described above, in the present specification, content may include plural pages and the display device may display the plural pages. In this case, the plural pages may be pages having various arrangement sequences.

In one embodiment, the plural pages may have 1-dimensional (1D) arrangement. When the plural pages have 1D arrangement, one or more pages may be present before and/or after a specific page 30010 among the plural pages. For example, as exemplarily shown in (a) of FIG. 3, one or more pages may be present at the left side and/or the right side of the specific page 30010. Alternatively, although not shown, one or more pages may be present at the upper side and/or the lower side of the specific page 30010. Here, the specific page 30010 may refer to a page that is being displayed on the display unit among the plural pages.

In another embodiment, the plural pages may have 2D arrangement. When the plural pages have 2D arrangement, one or more pages may be present at the upper side, the lower side, the left side and/or the right side of the specific page 30010 among the plural pages. For example, as exemplarily shown in (b) of FIG. 3, one or more pages may be present at the upper side, the lower side, the left side and/or the right side of the specific page 30010. Here, the specific page 30010 may refer to a page that is being displayed on the display unit among the plural pages.

In a further embodiment, the plural pages may have circular arrangement. Differently from the 1D arrangement and the 2D arrangement in which the first page and the last page are present, the circular arrangement has no first page and no last page, thus ensuring continuity in page transition. Accordingly, the plural pages having the 1D arrangement and the 2D arrangement may confront end of page transition based on page transition input, whereas the plural pages having circular arrangement may not confront end of page transition. That is, in the plural pages having the circular arrangement, page transition in any direction is always possible.

Note that various other arrangements of plural pages in different directions and different forms may be possible and the disclosure is not limited to the above embodiments. That is, in the present specification, the plural pages may have various sequences and the sequences may be determined according to design of the device, an application that is being executed and user settings, without being limited to the above embodiments.

Hereinafter, for convenience of description, the display device will be described as providing plural pages having 1D arrangement in which one or more pages are present at the left side or the right side of a first page that is a page being displayed on the display unit.

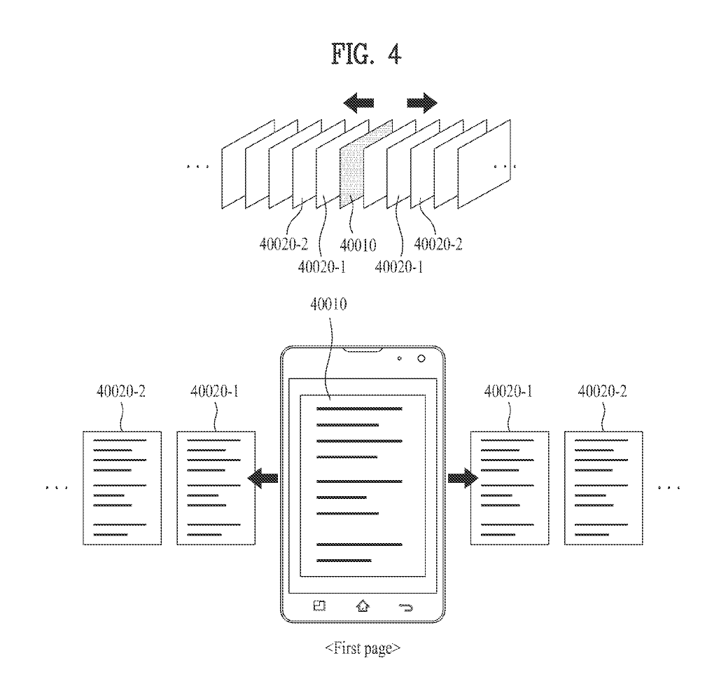

FIG. 4 is a view showing one embodiment of a display device displaying a first page.

In the present specification, a first page 40010 may be a page that is being displayed on the display unit. In this case, page transition from the first page 40010 to a second page 40020-1 arranged at the left side or the right side of the first page 40010 may be implemented in response to user page transition input. That is, the second page 40020-1 may be a page that is being displayed on the display unit after completion of page transition from the first page 40010. More specifically, upon detection of page transition input with respect to the first page 40010, the display device may switch the first page 40010 to another page, and the page displayed when the page transition in response to the page transition input is completed may be referred to as the second page 40020-1. Assuming that two or more pages among plural pages included in content are simultaneously displayed on the display unit, the first page 40010 may be at least one page that is being displayed on the display unit and the second page 40020-1 may be a page that will be additionally displayed in response to page transition input with respect to the first page 40010.

Accordingly, the second page 40020-1 may be a page located in a forward, backward, upward or downward direction on the basis of the first page 40010. In addition, the second page 40020-1 may be a previous page or next page of the first page 40010, or may be a page spaced apart from the first page 40010 by a predetermined number of pages. That is, no page or at least one page may be present between the first page 40010 and the second page 40020-1.

The display device may detect page transition input for switching the first page 40010 to the second page 40020-1. The display device may switch the first page 40010 to the second page 40020-1 in response to the detected page transition input and then may emit a scent corresponding to the second page 40020-1. In this case, the display device may detect a page transition speed from the first page 40010 to the second page 40020-1 in order to adjust a scent emission speed. The display device may detect the page transition speed in different ways when no page is present between the first page 40010 and the second page 40020-1 and when at least one page is present between the first page 40010 and the second page 40020-1. A detailed description related to this will follow with regard to FIGS. 5 and 6.

FIG. 5 is a view showing one embodiment of a display device detecting a page transition speed from a first page to a second page. In the present embodiment, a second page 50020 may be a previous page or next page of a first page 50010. In other words, the second page 50020 may be a page arranged before or after the first page 50010 in a given sequence.

The display device may detect page transition input 50030 for page transition from the first page 50010 to the second page 50020. In this case, the display device may detect a page transition speed V from the first page 50010 to the second page 50020 according to various embodiments.

In one embodiment, the display device may detect the page transition speed V by detecting a speed of the page transition input 50030. For example, the display device may detect a slide touch input 50030 as page transition input. The display device may switch the first page 50010 to the second page 50020 by moving the first page 50010 to follow a sliding direction and sliding speed of the detected slide touch input 50030. More specifically, when the slide touch input 50030 is implemented at a first speed V in a first direction, the display device may move the first page 50010 at the first speed V in the first direction. Since the first page 50010 is moved to follow the direction and speed V of the detected slide touch input 50030 as described above, the display device may detect the page transition speed V by detecting the sliding speed V of the slide touch input 50030.

In another embodiment, the display device may detect the page transition speed V by detecting time for transition from the first page 50010 to the second page 50020 after the first page 50010 is firstly displayed. The display device may acquire a time interval from a point in time when the first page 50010 is displayed on the display unit until the second page 50020 is displayed. More specifically, the display device may count time starting from a point in time when the first page 50010 is partially or wholly displayed. In this case, when the second page 50020 is displayed in response to page transition input from the first page 50010 to the second page 50020, the display device may stop time counting at a point in time when the second page 50020 is partially or wholly displayed. The display device may detect that the page transition speed V is fast as the acquired time interval is shorter and that the page transition speed V is slow as the acquired time interval is longer. That is, the display device may detect the page transition speed V inversely proportional to the acquired time interval.

Note that the display device may detect the page transition speed V according to various other embodiments and the disclosure is not limited to the above embodiments.

The display device, which has detected the page transition speed V, may control a scent emission speed by comparing the page transition speed V with a threshold speed. A detailed description related to this will follow with regard to FIG. 7.

Meanwhile, the page transition input for page transition from the first page 50010 to the second page 50020 may be any one of various touch inputs to the display unit, without being limited to the slide touch input 50030 as described above. Accordingly, the page transition input may be any one of various contact type or non-contact type touch inputs, such as multi-touch input, long-press touch input, short-press touch input, drag touch input, hovering input, flicking touch input and the like. In addition, the page transition input may be touch input to a page transition interface displayed for page transition.

FIG. 6 is a view showing one embodiment of a display device detecting a page transition speed from a first page to a second page. In the present embodiment, a second page 60020 may be a page spaced apart from a first page 60010 by at least one page. Alternatively, the second page 60020 may be a page spaced apart from the first page 60010 by a predetermined number of pages. In other words, at least one page 60030 may be present between the first page 60010 and the second page 60020.

When the at least one page 60030 is present between the first page 60010 and the second page 60020, the display device may detect the page transition speed V based on the number of pages n switched in a predetermined time t. More specifically, upon page transition from the first page 60010 to the second page 60020, the display device may acquire a time interval t for page transition from the first page 60010 to the second page 60020. The time interval t may be acquired by counting time starting from a point in time when the first page 60010 is partially or wholly displayed, and a detailed description related to this is equal to the above description with reference to FIG. 5. Moreover, the display device may acquire the number of pages n present between the first page 60010 and the second page 60020. The display device may detect the page transition speed V using the acquired time interval t and the acquired number of pages n. For example, the display device may detect the page transition speed V by dividing the acquired number of pages n by the acquired time interval t.

The display device, which has detected the page transition speed V according to the above embodiment(s) with regard to FIGS. 5 and 6, may control a scent emission speed to correspond to the detected page transition speed V. More specifically, upon page transition from the first page 60010 to the second page 60020, the display device may emit a scent corresponding to the second page 60020. In this case, the display device may detect the page transition speed V from the first page 60010 to the second page 60020 to adjust an emission speed of scent corresponding to the second page 60020. A detailed description related to this will follow with regard to FIG. 7.

FIG. 7 is a view showing one embodiment of a display device controlling a scent emission speed based on a page transition speed.

A display device 70010 may control a scent emission speed to correspond to the page transition speed V. In other words, the display device 70010 may detect the page transition speed V from a first page to a second page and control an emission speed of scent corresponding to the second page using the detected page transition speed V. Here, the emission speed of scent may refer to an emitted distance of scent molecules for a predetermined time. Accordingly, a fast scent emission speed may refer to a case in which scent molecules are moved by a long distance for a predetermined time, and a slow scent emission speed may refer to a case in which scent molecules are moved by a short distance for a predetermined time. Alternatively, a fast scent emission speed may refer to a case in which a short time is taken until scent molecules reach a predetermined distance, and a slow scent emission speed may refer to a case in which a long time is taken until scent molecules reach a predetermined distance.

To this end, first, the display device 70010 may detect the page transition speed V, and a detailed description related to this is equal to the above description with regard to FIGS. 5 and 6. Upon detecting the page transition speed V, the display device 70010 may compare the detected page transition speed V with a threshold speed Vt. When the page transition speed V exceeds the threshold speed Vt, the display device 70010 may emit a scent corresponding to a switched page (e.g., the second page) at a first emission speed v1. Conversely, when the page transition speed V is the threshold speed Vt or less, the display device 70010 may emit a scent corresponding to a switched page (e.g., the second page) at a second emission speed v2. Here, the first emission speed v1 may be faster than the second emission speed v2. Accordingly, the first emission speed v1 and the second emission speed v2 may be relative emission speeds.

For example, in a case in which the page transition speed V is detected using a sliding speed of a slide touch input, the display device 70010 may compare the acquired sliding speed with the threshold speed Vt. When the sliding speed exceeds the threshold speed Vt, the display device 70010 may emit a scent corresponding to the second page at the first emission speed v1. Conversely, when the sliding speed is the threshold speed Vt or less, the display device 70010 may emit the scent corresponding to the second page at the second emission speed v2.

That is, the display device 70010 may control a scent emission speed to increase as the page transition speed V increases and to decrease as the page transition speed V decreases. This allows the scent corresponding to a switched page to reach the user at a high speed when the user rapidly implements page transition, thereby providing the user with scent corresponding to each page in a more rapid manner. A scent has diffusion properties and, therefore, a given time may be required until the user perceives diffused scent. Accordingly, when the display device 70010 emits a scent corresponding to a switched page at a slow speed despite the fact that the user rapidly implements page transition, the user may confuse a scent corresponding to a page that is being displayed with scent corresponding to a switched page. As a result, each scent corresponding to each page may be transferred to the user at an inappropriate point in time. Accordingly, increasing a scent emission speed as the page transition speed increases may have the effect of appropriately providing the user with scent corresponding to a displayed page.

To this end, the display device 70010 may control a scent emission speed according to various embodiments.

In one embodiment, the display device 70010 may control the scent emission speed by controlling a scent emission intensity. In other words, the display device 70010 may control the scent emission speed by adjusting a scent emission degree or intensity by a scent emission unit that emits scents. More specifically, when the page transition speed V exceeds the threshold speed Vt, the display device 70010 may control the scent emission unit so as to emit a scent at a first intensity. Alternatively, when the page transition speed V is the threshold speed Vt or less, the display device 70010 may control the scent emission unit so as to emit a scent at a second intensity. In this case, the first intensity may be stronger than the second intensity. That is, in the case of fast page transition, the display device 70010 may emit a scent at a strong intensity to increase the scent emission speed. In the case of slow page transition, the display device 70010 may emit a scent at a weak intensity to decrease the scent emission speed.

In another embodiment, the display device 70010 may control the scent emission speed by adjusting a scent emission point in time. Upon emission of scent corresponding to a second page, the display device 70010 may a emit scent corresponding to the second page after a predetermined time has passed from a transition point in time to the second page. In this case, the display device 70010 may adjust the scent emission speed by adjusting the predetermined time. More specifically, when the page transition speed V exceeds the threshold speed Vt, the display device 70010 may a emit scent corresponding to the second page after a first time has passed from a transition point in time to the second page. Alternatively, when the page transition speed V is the threshold speed Vt or less, the display device 70010 may emit a scent corresponding to the second page after a second time has passed from a transition point in time to the second page. In this case, the first time may be shorter than the second time. That is, the display device 70010 may move up a scent emission point in time in the case of fast page transition to increase the scent emission speed, and may delay a scent emission point in time in the case of slow page transition to decrease the scent emission speed.

In a further embodiment, the display device 70010 may control the scent emission speed by activating a diffusion facilitating unit (not shown). Here, the diffusion facilitating unit, as described above, serves to facilitate diffusion of scent emitted from the scent emission unit. The display device 70010 may control activation of the diffusion facilitating unit by comparing the page transition speed V with the threshold speed Vt, thereby controlling the scent emission speed. More specifically, when the page transition speed V exceeds the threshold speed Vt, the display device 70010 may activate the diffusion facilitating unit to facilitate diffusion of scent emitted from the scent emission unit. Conversely, when the page transition speed V is the threshold speed Vt or less, the display device 70010 may inactivate the diffusion facilitating unit. That is, the display device 70010 may activate the diffusion facilitating unit to facilitate diffusion of scent in the case of fast page transition to increase the scent emission speed, and may inactivate the diffusion facilitating unit in the case of slow page transition to decrease the scent emission speed.

Note that the display device 70010 may control the scent emission speed according to various other embodiments and the disclosure is not limited to the above embodiments.

Meanwhile, although not shown in the drawing, in one embodiment, the display device 70010 may control a scent emission quantity according to the page transition speed V. More specifically, when the page transition speed V exceeds the threshold speed Vt, the display device 70010 may emit a first quantity of scent. Conversely, when the page transition speed V is the threshold speed Vt or less, the display device 70010 may emit a second quantity of scent. In this case, the first emission quantity may be less than the second emission quantity. This is because the emission quantity of scent is proportional to the mixing probability of previously scent and following scent in the case of fast page transition and, therefore, the user has difficulty in discriminating scents corresponding to respective pages. Accordingly, the display device 70010 may provide scent corresponding to each page in an appropriate manner by adjusting the scent emission quantity to correspond to the page transition speed V.

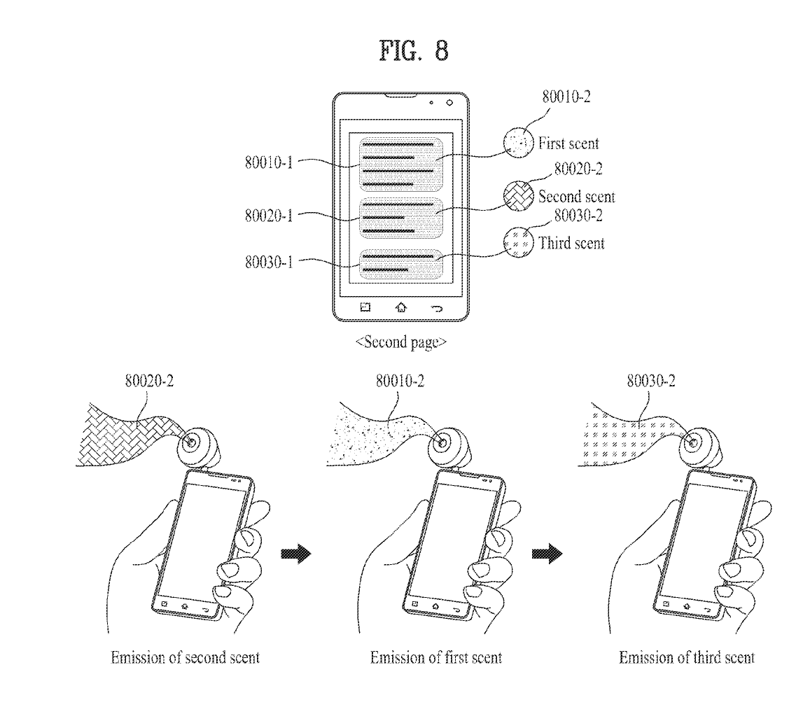

FIG. 8 is a view showing one embodiment of a display device emitting plural scents in a predetermined sequence.

A display device may emit a scent corresponding to a second page upon transition to the second page. In this case, there may be plural scents corresponding to the second page. For example, first scant 80010-2 may correspond to a first paragraph 80010-1 of the second page, second scant 80020-2 may correspond to a second paragraph 80020-1 of the second page and third scant 80030-2 may correspond to a third paragraph 80030-1 of the second page. Thus, the display device may emit the first scant 80010-2, the second scent 80020-2 and the third scent 80030-2 when the second page is displayed.

In this case, the display device may emit the plural scents 80010-2, 80020-2 and 80030-2 in a predetermined sequence. Here, the predetermined sequence may be determined based on the priority of scents, and may be set in various ways based on content of the entire page, content of each paragraph, a manufacturing method, design of the device, user settings and the like. Accordingly, the plural scents 80010-2, 80020-2 and 80030-2 may be emitted in a sequence different from the arrangement sequence of the paragraphs 80010-1, 80020-1 and 80030-1.

For example, as exemplarily shown in the drawing, the first scant 80010-2 may correspond to the second paragraph 80020-1 of the second page, the second scant 80020-2 may correspond to the first paragraph 80010-1 and the third scant 80030-2 may correspond to the third paragraph 80030-1. In this case, the display device may emit scents in the sequence of the second scent 80020-2→the first scent 80010-2→the third scent 80030-2, rather than the sequence of the first scent 80010-2→the second scent 80020-2→the third scent 80030-2.

The above embodiment, in particular, may be applied when the page transition speed exceeds the threshold speed. When the page transition speed is fast, the display device may preferentially emit a scent having a high order of priority in each page. Thereby, the display device has the effect of rapidly providing the user with scent having a high order of priority in each page to correspond to the fast page transition speed. Meanwhile, when the page transition speed is the threshold speed or less, the display device may emit the plural scents 80010-2, 80020-2 and 80030-2 to correspond to the arrangement sequence of the paragraphs 80010-1, 80020-1 and 80030-1.

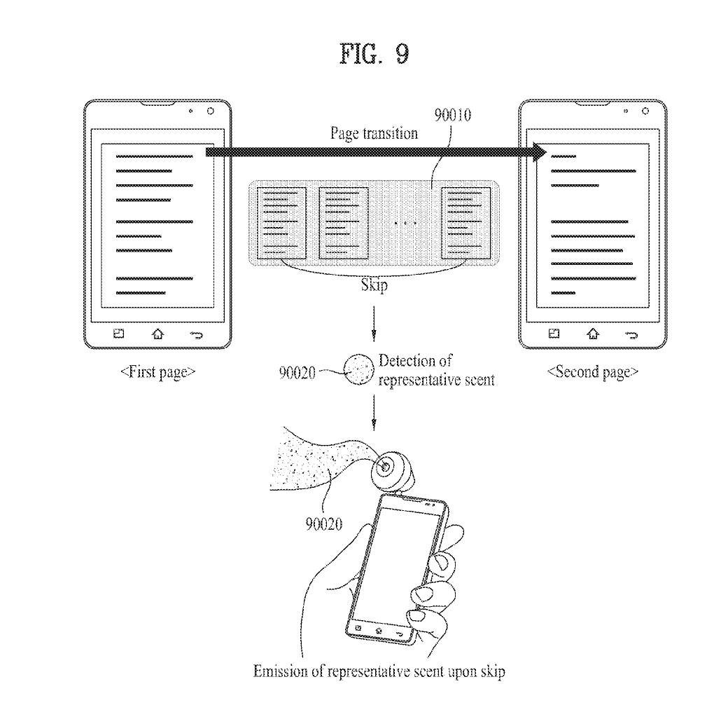

FIG. 9 is a view showing one embodiment of a display device emitting representative scent among plural scents corresponding to plural pages.

When plural pages 90010 are present between a first page and a second page, the display device may emit representative scent 90020 among plural scents corresponding to the plural pages 90010 upon transition to the second page.

More specifically, the plural pages 90010 may be present between the first page and the second page and plural scents corresponding to the plural pages 90010 may be present. When the page transition speed from the first page to the second page exceeds the threshold speed or direct transition from the first page to the second page is implemented in response to page transition input, the display device may emit the representative scent 90020 among the plural scents corresponding to the plural pages 90010 between the first page and the second page. Here, direct page transition from the first page to the second page may refer to a case in which the plural pages 90010 present between the first page and the second page are skipped and the second page directly follows the first page.

In this case, the display device may determine a scent, corresponding to a page that includes a climax or highlight of content among the plural pages 90010, as the representative scent 90020. Accordingly, in the case of fast page transition or page skip, the display device may emit only the representative scent 90020 such that the representative scent 90020 is imprinted on the user's mind. In addition, in consideration of the fact that the nose is most sensitive sensory organ and easily get tired, emitting the representative scent 90020 alone has the effect of not excessively stimulating the sense of smell of the user. Note that the representative scent 90020 may be selected according to various other embodiments and the disclosure is not limited to the above embodiments.

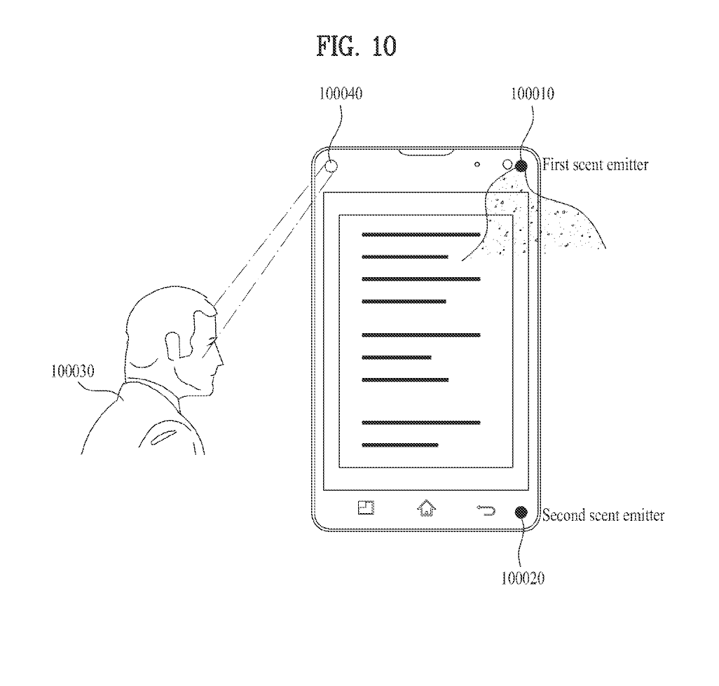

FIG. 10 is a view showing one embodiment of a display device including a plurality of scent emitters.

The display device may include a scent emission unit that emits scents. In this case, the scent emission unit may include a plurality of scent emitters 100010 and 100020. The scent emitters 100010 and 10020 included in the scent emission unit may be located respectively at different positions on the display device. For example, the scent emission unit may include a first scent emitter 100010 and a second scent emitter 100020. In this case, the first scent emitter 100010 may be located at an upper end of the display device and the second scent emitter 100020 may be located at a lower end of the display device (see FIG. 10).

In this case, the display device may detect a page transition speed and selectively activate a specific scent emitter(s) among the plural scent emitters 100010 and 100020 located at different positions based on the detected page transition speed.

In one embodiment, the display device may detect the position of a user 100030 using a camera unit 100040 and selectively activate at least one of the scent emitters 100010 and 100020 on the basis of the position of the user 100030. More specifically, when the page transition speed exceeds a threshold speed, the display device may detect an image of the user 100030 by activating the camera unit 100040. Here, the image of the user 100030 may be an image representing the body of the user 100030 (e.g., the face and the eyes). Upon detection of the image of the user 100030, the display device may detect a position where the image of the user 100030 is detected. When the image of the user 100030 is detected at a first position, the display device may selectively activate the first scent emitter 100010 that corresponds to the first position among the scent emitters 100010 and 100020 such that the first scent emitter 10010 emits a scent.

For example, when the display device detects an image of the user 100030 thereabove, the display device may activate the first scent emitter 100010 located at the upper end thereof to emit a scent from the first scent emitter 100010. This is in the same vein as that a scent emission speed increases when the page transition speed exceeds the threshold speed. That is, when emitting scent by activating the scent emitter 100010 located closest to the user 100030, time taken until scent molecules reach the user 100030 decreases and, consequently, the effect of increasing a scent emission speed may be anticipated.

In addition, the position of the user 100030 may be detected using various sensors, some of the plural scent emitters 100010 and 100020 may be selectively activated based on the detected result, and emission of scent may be implemented using the activated scent emitter(s).

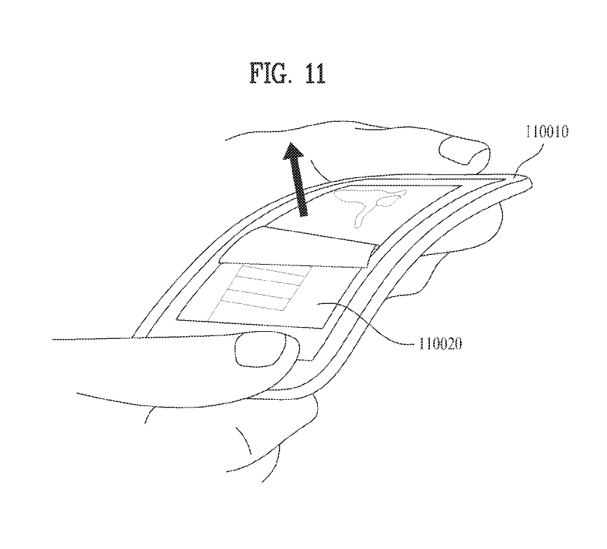

FIG. 11 is a view showing one embodiment of a display device including a flexible display panel.

The above embodiments may be equally or similarly applied even in the case of a display device 110010 in which a display unit takes the form of a flexible display panel. Thus, likewise, the display device 110010 including the flexible display panel may control a scent emission speed based on a page transition speed of displayed content 110020. Here, the flexible display panel may refer to a display panel in which change of the length, the area and/or the bending degree, for example, is possible.

The display device 110010 including the flexible display panel may detect bending of the flexible display panel as page transition input. That is, as exemplarily shown in the drawing, bending the flexible display panel such that the center thereof protrudes may be detected as page transition input. Moreover, the display device may detect a page transition speed by detecting a bending degree. For example, when the bending degree exceeds a threshold value, the display device 110010 may detect that the page transition speed exceeds a threshold speed. Alternatively, when the bending degree is the threshold value or less, the display device 110010 may detect that the page transition speed is the threshold speed or less.

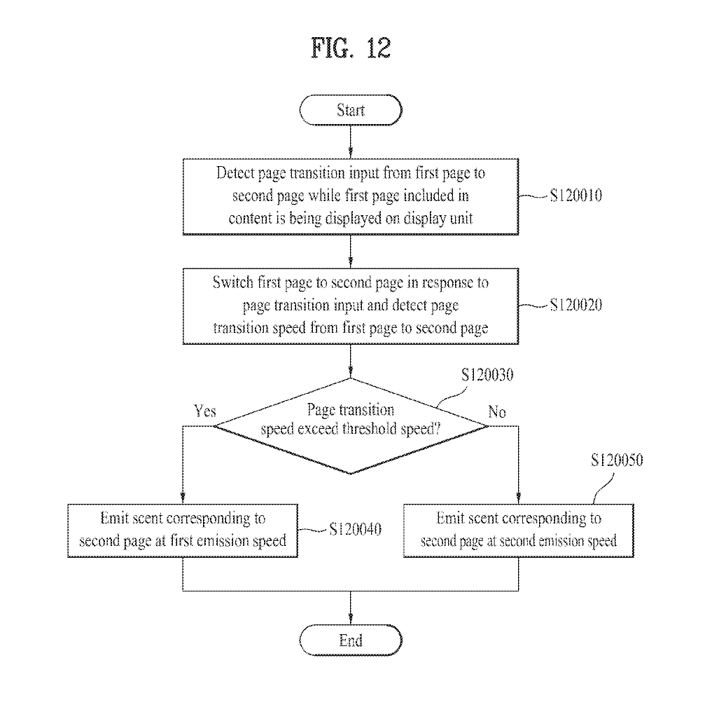

FIG. 12 is a flowchart showing a control method of a display device. In the flowchart, a detailed description related to parts similar to or overlapping with the above description with reference to FIGS. 1 to 11 will be omitted.

First, the display device may detect page transition input for page transition from a first page to a second page while the first page included in content is being displayed on a display unit (S120010). Here, the second page may be a previous page or next page of the first page. Alternatively, the second page may be a page spaced apart from the first page by a predetermined number of pages. The display device may detect various inputs to the first page as the page transition input. For example, the display device may detect, as the page transition input, slide touch input to the first page, touch input to a page transition interface, bending input and the like. A detailed description related to this is equal to the above description with regard to FIGS. 5 and 6.

Next, the display device may implement page transition from the first page to the second page in response to the page transition input and detect a page transition speed from the first page to the second page (S120020). The display device may detect the page transition speed from the first page to the second page according to various embodiments. In one embodiment, when slide touch input is detected as the page transition input, the display device may detect the page transition speed based on a sliding speed of the slide touch input. In another embodiment, when bending input is detected as the page transition input, the display device may detect the page transition speed based on a bending degree. A detailed description related to this is equal to the above description with regard to FIGS. 5 and 11.

Next, the display device may determine whether or not the page transition speed exceeds a threshold speed (S120030). Here, the threshold speed may be set to various values according to a manufacturing method adopted by a manufacturer, manufacturing process, device design, user settings and the like.

When the page transition speed exceeds the threshold speed, the display device may emit a scent corresponding to the second page at a first emission speed (S120040). Conversely, when the page transition speed is the threshold speed or less, the display device may emit a scent corresponding to the second page at a second emission speed (S120050). Here, the first emission speed may be faster than the second emission speed. This allows scent corresponding to a switched page to reach the user at a high speed when the user rapidly implements page transition, thereby providing the user with scent corresponding to each page in a more rapid manner. The display device may control a scent emission speed by controlling an emission intensity, an emission quantity, a scent emission point in time, activation of a diffusion facilitating unit, activation of a scent emitter and the like. A detailed description related to this is equal to the above description with regard to FIG. 7.

As is apparent from the above description, according to the present specification, a scent emission speed is controlled based on a page transition speed. Thus, when a user rapidly implements page transition, it is possible to allow scent corresponding to a switched page to reach the user at a high speed. This has the effect of providing the user with scent corresponding to each page in a more rapid manner.

Further, according to another embodiment, the scent emission speed may be controlled by adjusting a scent emission point in time, a scent emission intensity, a diffusion facilitating unit, a scent emission quantity and the like. This has the effect of controlling the scent emission speed in a more efficient manner.

Furthermore, according to a further embodiment, upon emission of plural scents, scent having a high order of priority or representative scent may be preferentially emitted. Accordingly, even in the case of fast page transition speed, only representative scent corresponding to content or important scent having a high order of priority may be selectively emitted. This has the effect of efficiently providing scent having a high order of priority without excessively stimulating the sense of smell of the user.

In the above description, although the respective drawings show different embodiments for convenience of explanation, it will be appreciated that the embodiments illustrated in the respective drawings may be combined to realize new embodiments. Also, designing a computer readable recording medium in which problems for execution of the above described embodiments are recorded according to demands of those skilled in the art is within the scope of the present specification.

In addition, it will be understood that applications of the display device and the control method thereof according to the present invention are not limited to configurations and methods of the above described embodiments, and some or all of the respective embodiments may be selectively combined to realize various modifications.

Although the exemplary embodiments have been illustrated and described as above, of course, it will be apparent to those skilled in the art that the present specification is not limited to the above described particular embodiments, and various modifications and variations can be made in the present specification without departing from the spirit or scope of the present specification, and the modifications and variations should not be understood individually from the viewpoint or scope of the present specification.

In addition, the display device and the control method thereof according to the present specification may be realized as a processor readable code of a processor readable recording medium included in a network device. The processor readable recording medium may include all kinds of storage devices for storing data that can be read by a processor. Examples of the processor readable recoding medium include a ROM, a RAM, a CD-ROM, a magnetic tape, a floppy disc, and an optical data storage device, for example, and may be realized in the form of a carrier wave (for example, transmission via the Internet). Also, the processor readable recording medium may be distributed in a computer system connected thereto via a network, thereby serving to store and execute a processor readable code in a distributed processing manner.

In addition, in the present specification, a speed and a direction may be understood as not only referring to accurate values, but as also including a substantial speed and a substantial direction within a given range. That is, a speed and a direction of the present specification may refer to a substantial speed and a substantial direction, and a given tolerance may be present therebetween.

In addition, both the invention of a device and the invention of a method have been described in this specification, and thus descriptions of both the inventions may be complementary applied as necessary.

What is claimed is:

1. A display device comprising:
a scent emission unit configured to emit scents;
a sensor unit configured to sense input to the display device;
a display unit configured to display content including plural pages; and
a processor configured to control the scent emission unit, the sensor unit and the display unit,
wherein the processor is further configured to:
detect page transition input from a first page to a second page while the first page included in the content is being displayed on the display unit;
switch the first page to the second page in response to the detected page transition input and detect a page transition speed from the first page to the second page; and
emit a scent corresponding to the switched second page based on the detected page transition speed:
wherein the processor emits the scent at a first emission speed when the detected page transition speed exceeds a threshold speed,
wherein the processor emits the scent at a second emission speed when the detected page transition speed is equal to or less than the threshold speeds, and
wherein the first emission speed is faster than the second emission speed.

2. The display device according to claim 1, wherein the second page is a page located in a forward, backward, upward or downward direction on the basis of the first page.

3. The display device according to claim 2, wherein the second page is a next page or previous page of the first page.

4. The display device according to claim 3, wherein the processor is further configured to display the second page switched in response to the detected page transition input and emit a scent corresponding to the displayed second page.

5. The display device according to claim 1, wherein at least one page is present between the first page and the second page.

6. The display device according to claim 5, wherein, upon detection of the page transition speed from the first page to the second page, the processor is further configured to acquire a time interval for switching the first page to the second page and the number of pages present between the first page and the second page, and detect the page transition speed using the acquired time interval and the number of pages.

7. The display device according to claim 6, wherein, when plural pages are present between the first page and the second page, the processor is further configured to additionally emit representative scent among plural scents corresponding to the plural pages upon switching to the second page.

8. The display device according to claim 1, wherein, when two or more pages among the plural pages included in the content are simultaneously displayed on the display unit, the first page is a page being displayed on the display unit and the second page is a page to be additionally displayed in response to page transition input to the first page.

9. The display device according to claim 1, wherein, when plural scents correspond to the second page, the processor is further configured to sequentially emit the plural scents in a predetermined sequence.

10. The display device according to claim 1, wherein the processor is further configured to adjust the emission speed by adjusting a scent emission intensity of the scent emission unit.

11. The display device according to claim 1, wherein, upon emission of scent corresponding to the switched second page, the processor is further configured to:
emit the scent after a first time has passed from the time switched to the second page when the detected page transition speed exceeds a threshold speed; and
emit the scent after a second time has passed from the time switched to the second page when the detected page transition speed is equal to or less than the threshold speed,
wherein the first time is shorter than the second time.

12. The display device according to claim 1, further comprising a diffusion facilitating unit configured to facilitate diffusion of scent emitted from the scent emission unit,
wherein the processor is further configured to adjust the emission speed of scent from the scent emission unit by controlling the diffusion facilitating unit.

13. The display device according to claim 1, wherein the processor is further configured to display a page transition interface for switching the first page to the second page, and detect a touch input to the displayed page transition interface as the page transition input.

14. The display device according to claim 1, wherein the processor is further configured to detect a slide touch input to the first page as the page transition input.

15. The display device according to claim 14, wherein the processor is further configured to determine a page transition direction from the first page based on a sliding direction of the slide touch input.

16. The display device according to claim 14, wherein the processor is further configured to detect a sliding speed of the slide touch input as the page transition speed.

17. The display device according to claim 16, wherein the processor is further configured to:
emit the scent at the first emission speed when the sliding speed of the slide touch input exceeds the threshold speed, and
emit the scent at the second emission speed when the sliding speed of the slide touch input is equal to or less than the threshold speed.

18. The display device according to claim 1, wherein the scent emission unit comprises a plurality of scent emitters, and
wherein the scent emitters are located at different positions of the display device.

19. The display device according to claim 18, wherein the processor is further configured to emit a scent corresponding to the second page by selectively activating at least one or more of the plurality of scent emitters when the detected page transition speed exceeds the threshold speed.

20. The display device according to claim 19, further comprising a camera unit configured to capture an image,
wherein the processor is further configured to detect a user and a position of the user using the camera unit and selectively activate at least one or more of the scent emitters based on the detected position of the user.

21. The display device according to claim 1, wherein the processor is further configured to:
emit a first quantity of scent when the detected page transition speed exceeds the threshold speed; and
emit a second quantity of scent when the detected page transition speed is equal to or less than the threshold speed,
wherein the first emission quantity is less than the second emission quantity.

22. A control method of a display device, the display device comprising a scent emission unit configured to emit scents, the control method comprising:
detecting page transition input from a first page to a second page while the first page included in the content is being displayed on a display unit;
switching the first page to the second page in response to the detected page transition input and detecting a page transition speed from the first page to the second page; and
emitting scent corresponding to the switched second page based on the detected page transition speed,
wherein the emitting scent corresponding to the switched second page comprises:
emitting the scent at a first emission speed when the detected page transition speed exceeds a threshold speed,
emitting the scent at a second emission speed when the detected page transition speed is equal to or less than the threshold speed,
wherein the first emission speed is faster than the second emission speed.
